(19) United States
(12) Patent Application Publication
(10) Pub. No.: US 2007/0096601 A1
(43) Pub. Date: May 3, 2007

(54) Drive unit

(76) Inventors: Hirohisa Sueyoshi, Osaka (JP); Tadatomi Sougawa, Osaka (JP)

Correspondence Address: BRINKS HOFER GILSON & LIONE, P.O. BOX 10395, CHICAGO, IL, 60610, US

(21) Appl. No.: 11/589,475

(22) Filed: Oct. 30, 2006

(30) Foreign Application Priority Data
Nov. 1, 2005 (JP) 2005-318145

(51) Int. Cl. H02N 2/00

(52) U.S. Cl. 310/328; 310/323.02

(57) ABSTRACT

A drive unit of the present invention includes a piezoelectric element, a drive friction member fixed to one end of the piezoelectric element, and a movable member frictionally fitted to the drive friction member. By making the piezoelectric element expanded and contracted, the movable member is moved relative to the drive friction member. The leaf spring for pressing the movable member against the drive friction member is provided integrally with the movable member.

### RELATED APPLICATION

This application is based on Japanese Patent Application No. 2005-318145, the content of which is incorporated herein by reference.

### BACKGROUND OF THE INVENTION

The present invention relates to drive units, more particularly, to a drive unit which uses an electromechanical conversion element such as a piezoelectric element and which is suitably used for, for example, lens drive or precision stage drive.

Conventionally, there has been known such a drive unit 60 as shown in FIG. 6. This drive unit 60 is composed of a cylindrical-shaped weight 62 to be fixed to an immovable part of a device into which the drive unit 60 is to be incorporated, a piezoelectric element (electromechanical conversion element) 64 which is cylindrical-shaped as an example and of which one end in its expansion/contraction direction is fixed to the weight 62, for example, by adhesion, a drive friction member 66 which is a cylindrical bar-shaped member as an example and which is to be fixed to the other end of the piezoelectric element 64 in its expansion/contraction direction, for example, by adhesion, and a movable member 68 which is to be fitted to the drive friction member 66 by frictional force.

The movable member 68 includes a holder 72, which is a resin molded article, for holding a lens 70 which is an optical member. The holder 72 is so designed that the drive friction member 66 is slidably accepted into a generally V-shaped groove portion 74 formed in its side portion.

In the drive friction member 66, a sliding friction member 76 formed from, for example, an SUS plate is placed in contact at a portion where the drive friction member 66 is accepted into the groove portion 74 of the holder 72. The sliding friction member 76 is composed of a curved portion 78 curved in close contact along an outer circumferential surface of the drive friction member 66, and rectangular-shaped protruding portions 80 protrusively provided on both sides of the curved portion 78, respectively. As the protruding portions 80 fit into recessed portions, respectively, formed on both sides of the holder 72 with the groove portion 74 interposed therebetween, the sliding friction member 76 is positioned with respect to the holder 72.

The sliding friction member 76 is pressed by a leaf spring (press member) 82 bent into an L shape. An end portion of the leaf spring 82 is fixed to the holder 72 by a screw 84. By biasing force of the leaf spring 82, the drive friction member 66 is pressed and sandwiched by the groove portion 74 of the holder 72 and the curved portion 78 of the sliding friction member 76, so that the movable member 68 is frictionally fitted to the drive friction member 66. It is noted that the means for mounting the leaf spring 82 to the holder 72 is not limited to screwing, and the leaf spring 82 may be fitted and mounted by, for example, snapping.

Next, operation of the drive unit 60 having the above-described construction is explained.

As a voltage is applied from a drive circuit not shown in figures to the piezoelectric element 64, the piezoelectric element 64 vibrates in expansion and contraction in the axial direction thereof. For instance, when a pulse voltage having a steep rise and a gentle fall is applied, the piezoelectric element 64 steeply extends and then contracts slowly. This expansion-and-contraction operation is transferred to the drive friction member 66, by which the drive friction member 66 is steeply moved to return to its original position. When the drive friction member 66 steeply moves, the movable member 68 is inclined to stay in situ by the inertia force of the movable member 68, giving rise to a slide between the groove portion 74 of the holder 72 and the drive friction member 66. Then, when the drive friction member 66 returns to the original position slowly, the movable member 68 moves together with the drive friction member 66 without occurrence of the slide. By repetition of such expanding/contracting vibrations, the movable member 68 moves to approach the piezoelectric element 64.

In a principle converse to the above, when a pulse voltage having a gentle rise and a steep fall as an example is applied to the piezoelectric element 64, the movable member 68 moves to go away from the piezoelectric element 64.

It is to be noted that JP H8-149860 A would be recited as an exemplary prior art document which relates to the present invention.

For assembly of the conventional drive unit 60 described above, the leaf spring 82 has to be fixed to the holder 72 by screwing and moreover the sliding friction member 76 needs to be assembled. Thus, the assembly would involve time and labor. It can also occur that the leaf spring 82 is plastically deformed during the assembly. In this case, there would arise variations in frictional force among individual units, lead also a cause of variations in unit performance. Furthermore, there has also been a possibility that component parts might be decomposed and scattered upon a shock of fall.

### SUMMARY OF THE INVENTION

An object of the present invention is to provide a drive unit which makes it possible to achieve a cost reduction by a cut of assembling steps, suppression of variations in drive performance by a reduction of plastic deformation of the leaf spring, and prevention of decomposition and scattering of component parts due to a shock of fall.

In order to achieve the above object, the present invention provides a drive unit comprising:

an electromechanical conversion element;

a drive friction member which is fixed to one end of the electromechanical conversion element; and

a movable member which is functionally fitted to the drive friction member, where the movable member is to be moved relative to the drive friction member by making the electromechanical conversion element vibrated in expansion and contraction, wherein

a press member for pressing the movable member against the drive friction member is constructed integrally with the movable member.

In the drive unit of the present invention, the movable member may include a sliding portion and a sliding friction member which abut on the drive friction member, respectively. The drive friction member may be formed into a cylindrical bar shape in general and the sliding portion of the movable member may be formed as a generally V-shaped groove. Moreover, the drive friction member may be formed into a cylindrical bar shape in general and the sliding friction member may have a curved portion corresponding to an outer circumference of the drive friction member.

Also, in the drive unit of the present invention, the press member may press the sliding friction member against the drive friction member. The press member and the sliding friction member may be mechanically positioned with each other.

Also, in the drive unit of the present invention, the press member may abut on the drive friction member directly. An abutting portion of the press member may have a curved shape along an outer circumference of the drive friction member. Moreover, the press member may be a leaf spring which is supported in a cantilever manner by the movable member.

Also, in the drive unit of the present invention, the movable member may include a holder which is made from a resin material and which holds a driven article, and the press member may be constructed integrally with the holder. The press member may be insert molded with the holder to form an integrated member. Moreover, the movable member may further include a sliding friction member and the holder has a sliding portion, and both of the sliding friction member and the sliding portion which abut on an outer circumference of the drive friction member may be formed from a metal material.

Also, in the drive unit of the present invention, the press member may be formed so as to be twistable with respect to an axial direction of the drive friction member that is an axial member. The press member may have at least two arm portions which are spaced from each other in the axial direction and which are generally perpendicular to the axial direction. Moreover, the two arm portions may be formed by cutting ½ or more of a width of the press member in the axial direction of the drive friction member.

Also, in the drive unit of the present invention, the press member may have a base portion formed narrower than its contact portion with the drive friction member. The base portion may be formed by cutting ½ or more of a width of the press member in the axial direction of the drive friction member.

Furthermore, the present invention provides as another aspect a drive unit comprising:

an electromechanical conversion element;

a drive friction member which is fixed to one end of the electromechanical conversion element;

a movable member which is functionally fitted to the drive friction member, where the movable member is to be moved relative to the drive friction member by making the electromechanical conversion element vibrated in expansion and contraction; and

a press member which is constructed integrally with the movable member so as to press the movable member against the drive friction member, wherein

the movable member includes a holder which is made from a resin material and which holds a driven article, the press member is constructed integrally with the holder, the holder has a sliding portion made from a metal material which abut on an outer circumference of the drive friction member, and the press member is a leaf spring formed so as to be twistable with respect to an axial direction of the drive friction member that is an axial member.

According to the drive unit of the present invention, since the press member is provided integrally with the movable member, for example, by insert molding, the assembling step for the press member can be omitted, allowing a cost reduction to be achieved, and moreover the press member is free from separation from the movable member due to a shock of fall.

Further, in the case where the press member is provided so as to abut directly on the drive friction member so that the sliding friction member is omitted, a further cost reduction can be achieved and moreover the assembly becomes easier to carry out. Still more, whereas expanding the press member by hand for assembling of the sliding friction member in the assembly process would cause the press member to be plastically deformed, making a factor of variations in frictional force and unit performance, the omission of the sliding friction member allows such events to be reduced.

Furthermore, in the case where the press member is formed so as to be twistable with respect to the axial direction of the drive friction member that is an axial member, even if the press member, when provided integrally with the movable member, has resulted into a skew more or less, generally uniform pressing force can be made to act on the drive friction member in the axial direction so that variations in the frictional force and the drive performance can be reduced.

### BRIEF DESCRIPTION OF THE DRAWINGS

The present invention will be further described with reference to the accompanying drawings wherein like reference numerals refer to like parts in the several views, and wherein:

FIG. 1 is an exploded perspective view of a drive unit;

FIGS. 2A and 2B are views showing a state in which a leaf spring is insert molded in a skew into a holder;

FIGS. 3A to 3C are views showing a drive unit using a leaf spring having two arm portions;

FIG. 4 is a view showing a drive unit in which a thinner portion is provided at a base portion of the leaf spring;

FIGS. 5A and 5B are views showing a drive unit in which metal material is provided at a sliding portion of the holder; and

FIG. 6 is a view showing a drive unit according to a prior art.

### DETAILED DESCRIPTION OF THE PREFERRED EMBODIMENTS

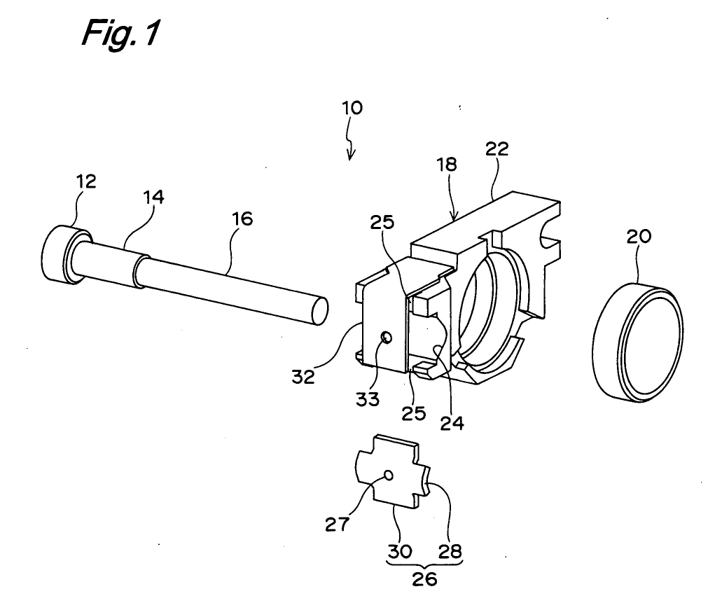

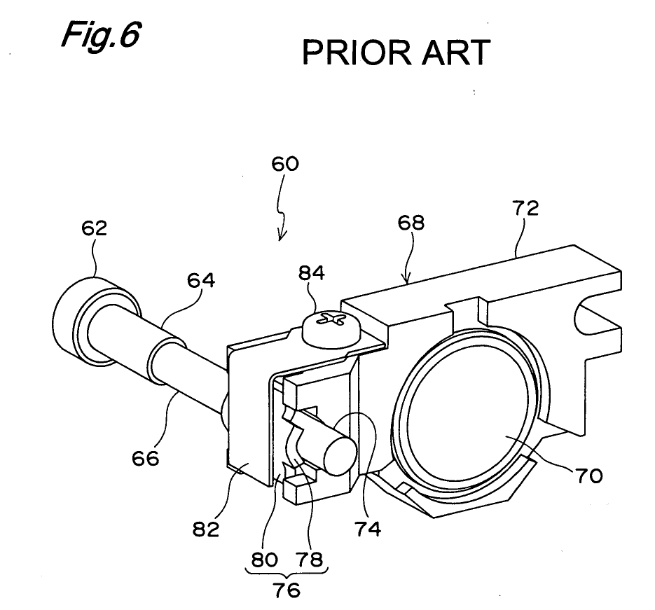

FIG. 1 is an exploded perspective view of a drive unit 10 which is an embodiment of the present invention, where an assembled state of the drive unit 10 is nearly identical to that shown in FIG. 6.

The drive unit 10 is composed of a cylindrical-shaped weight 12 to be fixed to an immovable part of a device into which the drive unit 10 is to be incorporated, a piezoelectric element (electromechanical conversion element) 64 which is cylindrical-shaped as an example and of which one end in its expansion/contraction direction is fixed to the weight 12, for example, by adhesion, a drive friction member 16 which is a cylindrical bar-shaped member as an example and which is to be fixed to the other end of the piezoelectric element 14 in its expansion/contraction direction, for example, by adhesion, and a movable member 18 which is to be fitted to the drive friction member 16 by frictional force. The cylindrical bar shape of the drive friction member 16 allows the drive friction member 16 to be easily produced with high dimensional accuracy.

The movable member 18 includes a holder 22, which is a resin (e.g., PPS (Polyphenylene Sulfide), liquid crystal polymer) molded article, for holding a lens 20 which is an optical member. The holder 22 is so designed that the drive friction member 16 is slidably accepted into a generally V-shaped groove portion 24 formed in its side portion. Forming the holder 22 with the resin material is effective to reduce the weight and production cost of the movable member 18.

In the drive friction member 16, a sliding friction member 26 formed from, for example, an SUS plate is placed in contact at a portion where the drive friction member 16 is accepted into the groove portion 24 of the holder 22. The sliding friction member 26 is composed of a curved portion 28 curved in close contact along an outer circumferential surface of the drive friction member 16, and rectangular-shaped protruding portions 30 protrusively provided on both sides of the curved portion 28, respectively. As the protruding portions 30 fit into recessed portions, respectively, formed on both sides of the holder 22 with the groove portion 24 interposed therebetween, the sliding friction member 26 is positioned with respect to the holder 22. The curved shape of the sliding friction member 26 allows the sliding friction member 26 to easily accept the drive friction member 16 during the assembly of the drive unit 10.

The sliding friction member 26 is pressed by a leaf spring (press member) 32 bent into an L shape. The leaf spring 32 formed from a metal plate is provided integrally with the holder 22, which is a resin molded article, by insert molding. The leaf spring 32 is supported in the cantilever manner by the holder 22, so that the leaf spring 32 facilitates an adjustment of biasing force thereof and has high tolerance to the twist from an original posture with respect to the holder 22, in comparison with those in the leaf spring both ends of which are fixed to the holder 22. By biasing force of the leaf spring 32, the drive friction member 16 is pressed and sandwiched by the groove portion 24 of the holder 22 and the curved portion 28 of the sliding friction member 26, so that the movable member 18 is frictionally fitted to the drive friction member 16.

A small protrusion 27 is formed on the surface of the sliding friction member 26, and a small hole 33 is formed in the leaf spring 32. As these protrusion 27 and the hole 33 are fitted to each other, the sliding friction member 26 is positioned with respect to the leaf spring 32, thereby omitting positioning adjustment of the sliding friction member 26 relative to the leaf spring to in turn make the assembly of the drive unit 10 easy.

Operation of the drive unit 10 having the above-described construction is absolutely similar to that of drive unit 60 described as a prior art example, and so its description is omitted here.

According to the drive unit 10 of this embodiment, since the leaf spring 32 is provided integrally with the movable member 18 by insert molding, the assembling step for the leaf spring 32 can be omitted, allowing a cost reduction to be achieved, and moreover the leaf spring 32 is free from separation from the movable member 18 due to a shock of fall.

In the drive unit 10 shown above, the drive friction member 16 is pressed by the leaf spring 32 via the sliding friction member 26. However, it is also possible that with the sliding friction member 26 omitted, the leaf spring 32 is set in direct contact with the drive friction member 16 so that the leaf spring 32 serves also as the sliding friction member. In this case, the sliding friction member 26 can be omitted, so that a further cost reduction can be achieved and moreover the assembly becomes easier to carry out. Still more, whereas expanding the leaf spring 32 by hand for assembling of the sliding friction member 26 in the assembly process would cause the leaf spring 32 to be plastically deformed, making a factor of variations in frictional force and drive performance, the omission of the sliding friction member 26 allows such events to be reduced.

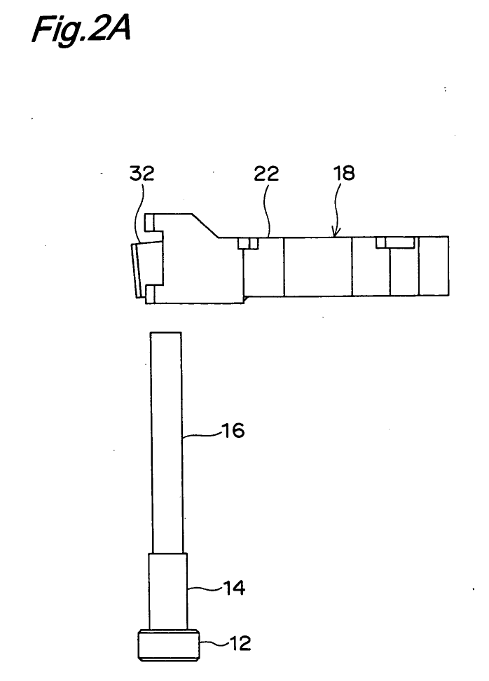

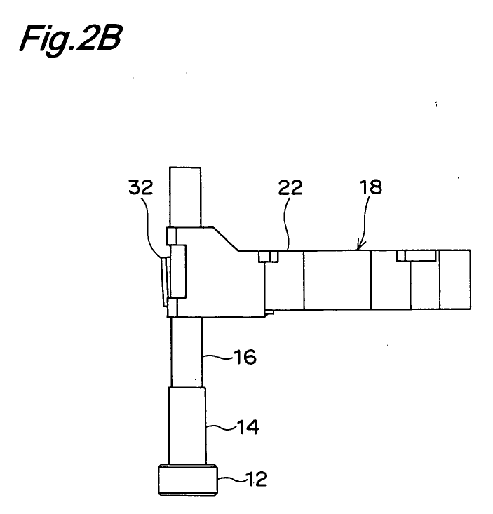

In the meantime, in the case where the leaf spring 32 is provided integrally with the movable member 18 by insert molding, there can occur a case where the leaf spring 32 is fixed in a skewed state with respect to the movable member 18 during the insert molding as shown in FIG. 2A. In such a case, after the assembly, the leaf spring 32 comes to be in one-side contact with the drive friction member 16 (or the sliding friction member 26 if it is present) as shown in FIG. 2B, resulting in unstable pressing force of the leaf spring 32. As a result, the frictional force of the movable member 18 against the drive friction member 16 is varied among individual units, causing the drive performance to be varied.

Thus, in order to prevent the event that the leaf spring 32 is fixed in a skew to make the pressing force unstable, it is also possible that the leaf spring 32 is formed so as to be twistable with respect to the axial direction of the drive friction member 16, which is an axial member.

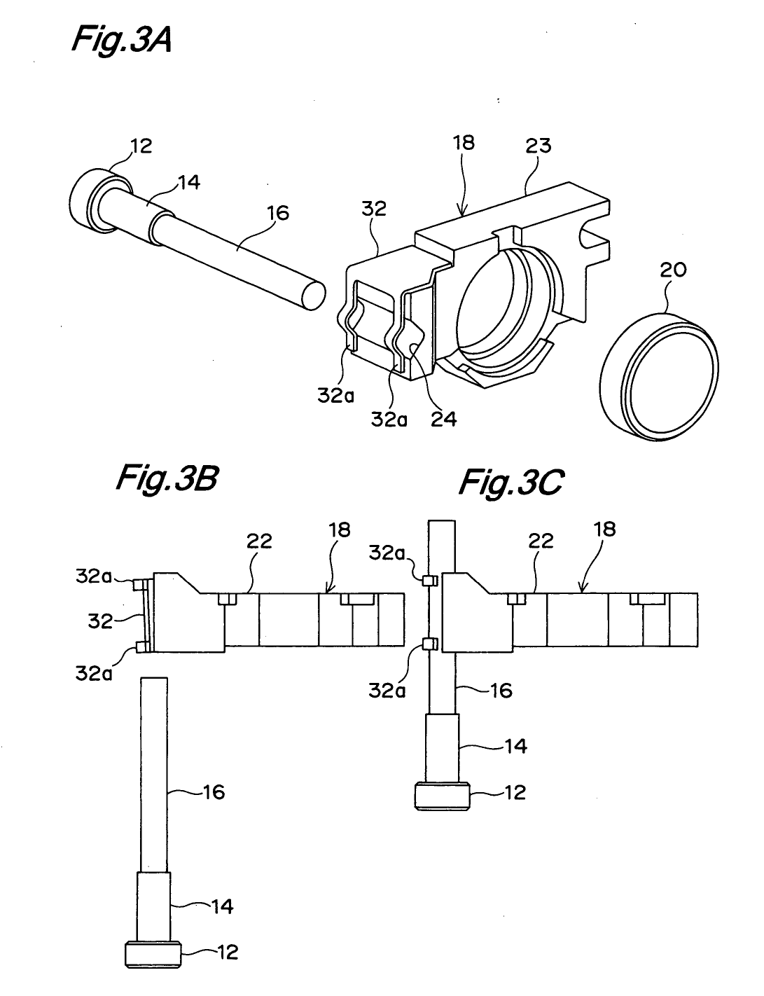

More specifically, as shown in FIG. 3A, the leaf spring 32 has two arm portions 32a which are spaced from each other in the axial direction of the drive friction member 16 and which are generally perpendicular to the axial direction. These arm portions 32a each have a central portion bent in a generally V-shape substantially along the outer circumferential surface of the drive friction member 16. With the two arm portions 32a provided in the leaf spring 32 as shown above, even in the case where the leaf spring 32 is fixed in a skew with respect to the holder 22 as shown in FIG. 2B, when the leaf spring 32 is assembled to the drive friction member 16, there arises a twist between the two arm portions 32a with respect to the axial direction of the drive friction member 16, so that the arm portions 32a are both brought into close contact with the drive friction member 16 as shown in FIG. 3B, thus allowing the active pressing force to be generally uniform. Thus, variations in the frictional force and the drive performance among individual units can be reduced. Alternatively, the arm portions 32a may be provided three or more in number without being limited to two.

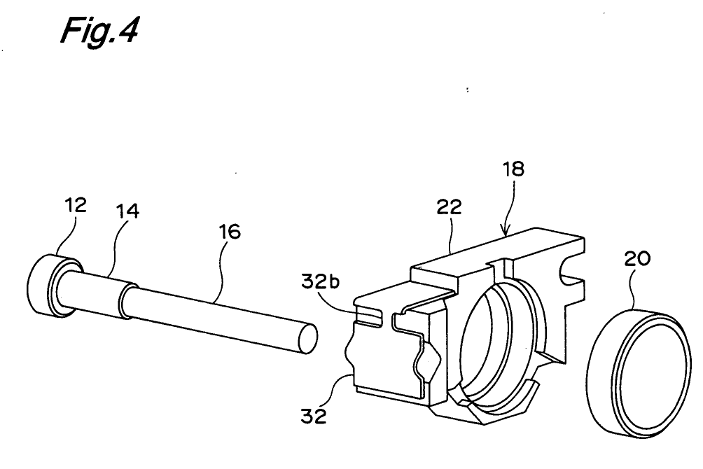

It is still along possible that, as shown in FIG. 4, a narrow portion 32b thinner than the contact portion with the drive friction member 16 is formed at a base portion of the leaf spring 32, so that the leaf spring 32 is allowed to twist at the narrowed portion 32b with respect to the axial direction of the drive friction member 16. In this case also, the portion of the leaf spring 32 that makes contact with the drive friction member 16 is bent in a generally V-shape substantially so as to extend along the outer circumferential surface of the drive friction member 16. As a result of this also, even in the case where the leaf spring 32 is fixed in a skew with respect to the holder 22, when the leaf spring 32 is assembled to the drive friction member 16, the leaf spring 32 is twisted at the narrowed portion 32b with respect to the axial direction of the drive friction member 16, so that the leaf spring 32 are brought into close contact with the drive friction member 16, allowing the active pressing force to be generally uniform. Thus, variations in the frictional force and the unit performance among individual units can be reduced.

Preferably, the two arm portions 32a of the leaf spring 32 shown in FIG. 3 and the narrowed portion 32b of the leaf spring 32 shown in FIG. 4 are formed by cutting out ½ or more of the width of the leaf spring 32 in the axial direction of the drive friction member 16 in order to provide the above-described successful twist function of the leaf spring 32.

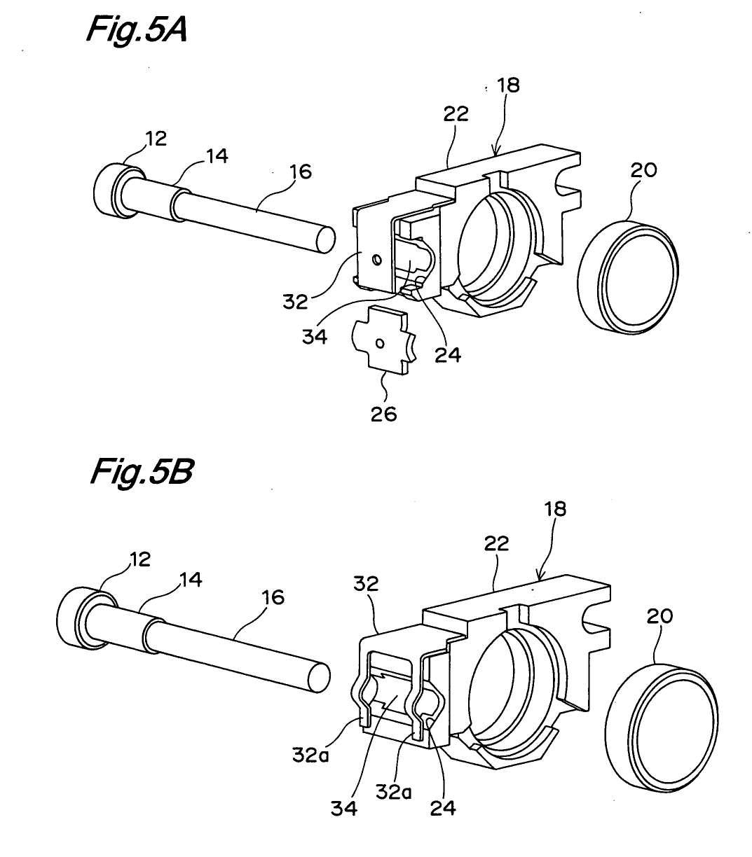

In the above-described drive unit 10, since the holder 22 is molded with a resin material, the inner surface of the groove portion 24 to make contact with the drive friction member 16 is formed also with resin. However, as shown in FIGS. 5A and 5B, the inner surface of the groove portion 24 in the holder 22, which serves as the sliding portion against the drive friction member 16, may be formed from a metal material 34. This metal material 34 may be provided integrally with by insertion during the molding of the holder 22, or provided by other means (adhesion, plating etc.). In the case where the sliding portion against the drive friction member 16 is formed from a metal material of higher rigidity than resin material as shown above, the drive performance can be improved and the durability of the movable member 18 against friction with the drive friction member 16 can be enhanced.

In addition, in the case where the arm portions 32a or the narrow portion 32b is formed in the leaf spring 32, it has been described that the leaf spring 32 serves also as the sliding friction member. However, such a leaf spring 32 may be used in combination with the sliding friction member 26.

Although the present invention has been fully described by way of examples with reference to the accompanying drawings, it is to be noted that various changes and modifications will be apparent to those skilled in the art. Therefore, unless otherwise such changes and modifications depart from the spirit and the scope of the present invention, they should be construed as being included therein.

### Attachment A

John C. Freeman (34,483)

John G. Rauch (37,218)

Andrew D. Stover (38,629)

Tadashi Horie (40,437)

Joseph F. Hetz (41,070)

James L. Katz (42,711)

James A. Collins (43,557)

Vincent J. Gnoffo (44,714)

What is claimed is:

1. A drive unit comprising:
an electromechanical conversion element;
a drive friction member which is fixed to one end of the electromechanical conversion element; and
a movable member which is functionally fitted to the drive friction member, where the movable member is to be moved relative to the drive friction member by making the electromechanical conversion element vibrated in expansion and contraction, wherein
a press member for pressing the movable member against the drive friction member is constructed integrally with the movable member.

2. The drive unit as claimed in claim 1, wherein the movable member includes a sliding portion and a sliding friction member which abut on the drive friction member, respectively.

3. The drive unit as claimed in claim 2, wherein the drive friction member is formed into a cylindrical bar shape in general and the sliding portion of the movable member is formed as a generally V-shaped groove.

4. The drive unit as claimed in claim 2, wherein the drive friction member is formed into a cylindrical bar shape in general and the sliding friction member has a curved portion corresponding to an outer circumference of the drive friction member.

5. The drive unit as claimed in claim 2, wherein the press member presses the sliding friction member against the drive friction member.

6. The drive unit as claimed in claim 5, wherein the press member and the sliding friction member are mechanically positioned with each other.

7. The drive unit as claimed in claim 1, wherein the press member abuts on the drive friction member directly.

8. The drive unit as claimed in claim 7, wherein an abutting portion of the press member has a curved shape along an outer circumference of the drive friction member.

9. The drive unit as claimed in claim 7, wherein the press member is a leaf spring which is supported in a cantilever manner by the movable member.

10. The drive unit as claimed in claim 1, wherein the movable member includes a holder which is made from a resin material and which holds a driven article, and the press member is constructed integrally with the holder.

11. The drive unit as claimed in claim 10, wherein the press member is insert molded with the holder to form an integrated member.

12. The drive unit as claimed in claim 10, wherein the movable member further includes a sliding friction member and the holder has a sliding portion, and both of the sliding friction member and the sliding portion which abut on an outer circumference of the drive friction member is formed from a metal material.

13. The drive unit as claimed in claim 1, wherein the press member is formed so as to be twistable with respect to an axial direction of the drive friction member that is an axial member.

14. The drive unit as claimed in claim 1, wherein the press member has at least two arm portions which are spaced from each other in the axial direction and which are generally perpendicular to the axial direction.

15. The drive unit as claimed in claim 14, wherein the two arm portions is formed by cutting ½ or more of a width of the press member in the axial direction of the drive friction member.

16. The drive unit as claimed in claim 1, wherein the press member has a base portion formed narrower than its contact portion with the drive friction member.

17. The drive unit as claimed in claim 16, wherein the base portion is formed by cutting ½ or more of a width of the press member in the axial direction of the drive friction member.

18. A drive unit comprising:
an electromechanical conversion element;
a drive friction member which is fixed to one end of the electromechanical conversion element;
a movable member which is functionally fitted to the drive friction member, where the movable member is to be moved relative to the drive friction member by making the electromechanical conversion element vibrated in expansion and contraction; and
a press member which is constructed integrally with the movable member so as to press the movable member against the drive friction member, wherein
the movable member includes a holder which is made from a resin material and which holds a driven article, the press member is constructed integrally with the holder, the holder has a sliding portion made from a metal material which abut on an outer circumference of the drive friction member, and the press member is a leaf spring formed so as to be twistable with respect to an axial direction of the drive friction member that is an axial member.
